(19) United States
(12) Patent Application Publication
(10) Pub. No.: US 2012/0077385 A1
(43) Pub. Date: Mar. 29, 2012

(54) CONNECTOR

(75) Inventor: YunLong Qiao, Singapore (SG)

(73) Assignee: 3M INNOVATIVE PROPERTIES COMPANY, Saint Paul, MN (US)

(21) Appl. No.: 13/375,773

(22) PCT Filed: May 27, 2010
(86) PCT No.: PCT/US2010/036340

§ 371 Date: Dec. 2, 2011

(30) Foreign Application Priority Data
Jun. 3, 2009 (SG) 200903792-0

(51) Int. Cl. H01R 31/06

(52) U.S. Cl. 439/628

(57) ABSTRACT

An electrical connector includes a housing having a base portion with first and second mating ends. The first mating end can couple with a first complementary connector with a plurality of slots in an extension from the base, the second mating end can couple with a second complementary connector with a tongue portion extending from the base portion and having a first and a second tongue section. The connector has a plurality of contacts extending from the extension to the tongue portion, each contact having a first and a second contact section and a bridging section connecting these sections. The contacts are grouped forming a first and second contact set wherein the first and second contact section of each contact in the first contact set are aligned substantially along an axis while the first and second contact sections in the second contact set are aligned along different axes.

### TECHNICAL FIELD

The present invention relates to a connector, in particular, an electrical connector for coupling devices with different hard disk drive interfaces.

### BACKGROUND

Hard disk drives (HDDs) are used to store digital data content for laptops, desktop computers, servers and other electronic devices in use today. Each of these electronic devices has its own requirements for the storage media to be used such as access time, capacity, form factor, reliability and data transmission rates.

An HDD interface is the communication channel over which the data flows as the data is read from or written to the HDD. Types of interfaces available today include Integrated Drive Electronics (IDE), Advanced Technology Attachment (ATA), Small Computer System Interface (SCSI), Serial ATA (SATA), Serial Attached SCSI (SAS), and micro SATA. It should be noted that the list of interfaces provided above is not exhaustive and is constantly increasing to keep pace with the ever changing demands of the electronic devices which dictate the specifications of the HDDs and their interfaces. In this document, the terms “interface” and “connector” are used interchangeably.

The SATA connector and the SAS connector are the two most commonly used connectors in the HDD industry today. According to the specifications set by the Small Form Factor (SFF) Committee, a SATA connector has 22 contacts (also referred to as “terminals” or “pins” in this document) of which 15 contacts are used for power transmission and 7 contacts are used for data signal transmission. In addition to the 22 contacts available in the SATA connector, an SAS connector has an additional 7 contacts (i.e. 29 contacts in total) for data signal transmission.

Along with the desire to have smaller electronic devices comes the need to have smaller physical size HDDs. Thus, there is an industry need to have a HDD connector with a smaller form factor (i.e. physical size) such as the micro SATA HDD connector. Similar to the SATA and SAS connector, the micro SATA connector has 7 data signal contacts. However, as a micro SATA HDD is physically smaller and a micro SATA HDD consumes less power, the micro SATA connector only requires 9 power contacts.

Available in the market today are specialized test equipments used for testing HDDs before they are released for sale. However, most of these test equipments are designed specifically for HDDs with a particular type of connector such as the SATA HDD connector or the SAS HDD connector. With the introduction of the micro SATA HDDs, the existing test equipments will either require modifications or replacement before the micro SATA HDDs may be tested. Both options will require the HDD testing companies to incur substantial new capital spending. Moreover, it may not be cost effective for the HDD testing companies to install and house multiple types of test equipments solely for the testing of HDDs of different HDD connectors such as SATA, SAS and micro SATA HDD connectors.

It would be desirable to provide an electrical connector that can be used to couple devices with different HDD connectors. It would be desirable if the electrical connector can further be used with existing test equipment for testing HDDs with different HDD connectors from that of the test equipment. It would also be desirable if the electrical connector may be attached to a backplane or a printed circuit board (PCB) of an existing test equipment so that the existing test equipment may be reconfigured to be used for testing HDDs with a different type of HDD connector.

### SUMMARY

In accordance with one embodiment of the present invention, there is provided an electrical connector comprising:

an elongated insulative housing having a longitudinal base portion with a first mating end and a second mating end;

wherein the first mating end is configured to couple with a first complementary electrical connector by means of a plurality of slots defined within an extension extending from the base portion;

wherein the second mating end is configured to couple with a second complementary electrical connector by means of a tongue portion extending from the base portion, the tongue portion comprising a first tongue section and a second tongue section; and

a plurality of contacts extending from the extension to the tongue portion, each contact comprising a first contact section, a second contact section and a bridging section connecting the first contact section to the second contact section, and the contacts are further grouped to form a first contact set and a second contact set wherein the first contact section and the second contact section of each contact in the first contact set are aligned substantially along a same axis whereas the first contact section and the second contact section of each contact in the second contact set are aligned along different axes.

In accordance with another embodiment of the present invention, there is provided an interconnect system comprising at least one electrical connector, a first complementary electrical connector and a second complementary electrical connector wherein the electrical connector is configured to couple the first complementary electrical connector and the second complementary electrical connector; and wherein

the first complementary electrical connector is attached to a printed circuit board which is attached to a hard disk drive;

the second complementary electrical connector is attached to a backplane which is attached to test equipment; and wherein

said electrical connector comprises:

an elongated insulative housing having a longitudinal base portion with a first mating end and a second mating end; wherein the first mating end is configured to couple with the first complementary electrical connector by means of a plurality of slots defined within an extension extending from the base portion and the second mating end is configured to couple with the second complementary electrical connector by means of a tongue portion extending from the base portion, the tongue portion comprising a first tongue section and a second tongue section; and

a plurality of contacts extending from the extension to the tongue portion, each contact comprising a first contact section, a second contact section and a bridging section connecting the first contact section to the second contact section, and the contacts are further grouped to form a first contact set and a second contact set wherein the first contact section and the second contact section of each contact in the first contact set are aligned substantially along a same axis whereas the first contact section and the second contact section of each contact in the second contact set are aligned along different axes.

In accordance with one embodiment of the present invention, there is provided an electrical connector on a backplane comprising:

an elongated insulative housing having a first mating end and a second mating end;

wherein the first mating end is configured to couple with a first complementary electrical connector by means of a plurality of slots defined within an extension extending from the first mating end of the housing; and

a plurality of contacts extending from the extension to the second mating end, each contact comprising a first contact section, a second contact section attached to the backplane and a bridging section connecting the first contact section to the second contact section, and the contacts are further grouped to form a first contact set and a second contact set wherein the first contact section and the second contact section of each contact in the first contact set are aligned substantially along a same axis whereas the first contact section and the second contact section of each contact in the second contact set are aligned along different axes.

The invention further includes any alternative combination of parts or features mentioned herein or shown in the accompanying drawings. Known equivalents of these parts or features which are not expressly set out are nevertheless deemed to be included.

### BRIEF DESCRIPTION OF THE DRAWINGS

An exemplary form of the present invention will now be described with reference to the accompanying drawings in which:

FIG. 1A is a perspective view of an existing interconnect system comprising a SATA socket attached to a backplane of a test equipment (not shown) and a SATA header attached to a printed circuit board (PCB) of a hard disk drive (HDD) (not shown);

FIG. 1B is a front view of an extension of the socket of FIG. 1A taken from a side facing a first mating surface of the socket;

FIG. 2 is a perspective view of an existing interconnect system comprising a SAS socket attached to a backplane of a test equipment (not shown) and a SATA header attached to a PCB of a HDD (not shown);

FIG. 3 is a perspective view of one embodiment of an interconnect system in accordance to an aspect of the present invention comprising a first complementary electrical connector attached to a PCB which is to be attached to a HDD (not shown), a second complementary electrical connector attached to a backplane which is to be attached to a test equipment (not shown) and one embodiment of an exemplary electrical connector according to an aspect of the present invention positioned between and ready to couple the first complementary electrical connector and the second complementary electrical connector;

FIG. 4 is an exploded perspective view of the exemplary electrical connector of FIG. 3;

FIG. 5 is a front view of an extension of the exemplary electrical connector of FIG. 3 taken from a first mating end;

FIG. 6A is a perspective view of one embodiment of a contact from a first contact set in accordance to an aspect of the present invention;

FIG. 6B is a perspective view of one embodiment of a contact from a second contact set in accordance to an aspect of the present invention;

FIG. 7A is a perspective section view of the contact of FIG. 6A being assembled into the exemplary electrical connector of FIG. 3;

FIG. 7B is a perspective section view of the contact of FIG. 6B being assembled into the exemplary electrical connector of FIG. 3;

FIG. 8 is a perspective view of one embodiment of an interconnect system in accordance to an aspect of the present invention comprising one embodiment of an exemplary electrical connector in accordance to an aspect of the present invention attached to a backplane which is to be attached to a test equipment (not shown) and a first complementary electrical connector attached to a PCB which is to be attached to a HDD (not shown);

FIG. 9A is a perspective view of one embodiment of a contact from a first contact set taken from the exemplary electrical connector of FIG. 8;

FIG. 9B is a perspective view of one embodiment of a contact from a second contact set taken from the exemplary electrical connector of FIG. 8; and

FIG. 10 is a perspective view of the exemplary electrical connector of FIG. 8 attached to another backplane.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

Hard disk drives (HDDs) are used to store digital data content for many types of electronic devices today, including but not limited to, laptops, desktop computers, servers, etc. The requirements and specifications such as access time, capacity, form factor, reliability, data transmission rates, etc., of the HDDs will depend on the type of electronic devices in which the HDDs are to be installed.

An HDD interface is the communication channel over which the data flows as the data is read from or written to the HDD. The Serial Advanced Technology Attachment (SATA) and the Serial Attached Small Computer System Interface (SAS) are two most commonly used interfaces (connectors) for HDDs today. In this document, the terms “interface” and “connector” are used interchangeably.

According to specifications set by the Small Form Factor (SFF) Committee, a SATA connector has 22 contacts (also referred to as “terminals” or “pins” in this document) of which a first section of 7 contacts are used for data signal transmission and a second section of 15 contacts are used for power transmission. In the case of a SAS connector, there is an additional third section of 7 contacts dedicated for data signal transmission.

As the electronic devices get smaller in size, it is necessary to reduce the size of the HDDs and their connectors so that these HDDs may be fitted into the electronic devices. A HDD connector commonly used with smaller form factor HDDs is the micro SATA connector. Since a micro SATA HDD consumes less power than a standard SATA HDD or SAS HDD, the micro SATA connector requires only 9 power contacts. Thus, a micro SATA connector has a total of 16 contacts of which a first section of 7 contacts are used for data signal transmission and a second section of 9 contacts are used for power transmission.

The HDDs have to be tested using specialized test equipments before they are released for sale or for use with the electronic devices. Each test equipment often have a specific type of HDD connector attached to the backplane (also referred to as “printed circuit board”) and therefore, the test equipment can only be used to test HDDs with that particular HDD connector or connectors that are compatible to that particular HDD connector attached to the backplane.

To facilitate the explanation and illustration of the invention, references are made herein to specific electrical connectors such as SATA, SAS and micro SATA HDD connectors. It is important to note that such references are not intended to and should not be used to limit the invention to just the forms or the types of electrical connectors referenced.

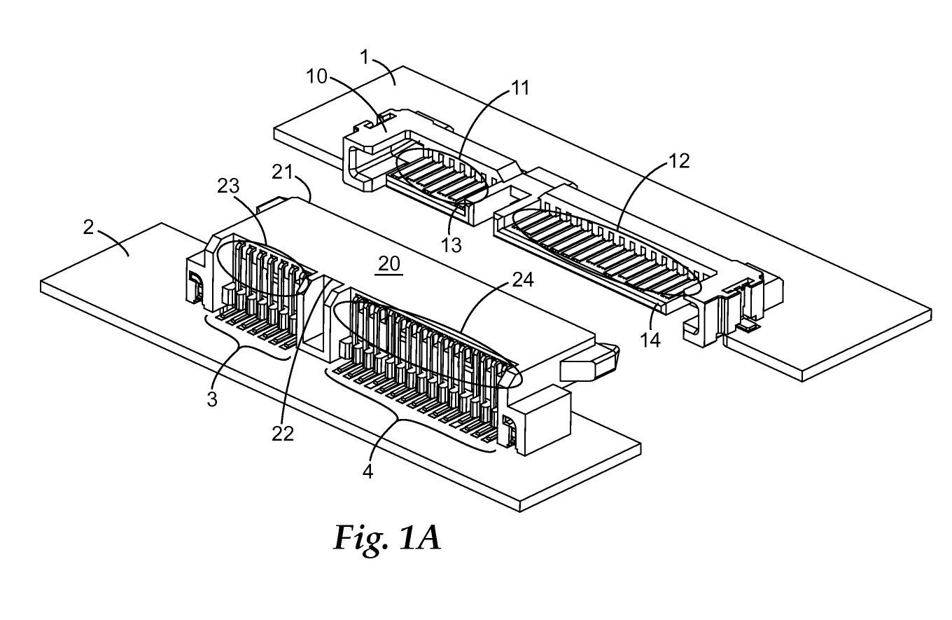

FIG. 1A is a perspective view of an existing interconnect system comprising a backplane connector 20 such as a SATA socket attached via soldering means to a backplane 2 which is attached to a test equipment (not shown) used for testing HDDs before the HDDs are put on sale or are installed in electronic devices and a first complementary electrical connector 10 such as a SATA header attached to a printed circuit board (PCB) 1 which is attached to a HDD (not shown) to be tested. It is important to note that a connector may be attached to a PCB using a variety of ways and devices in addition to soldering including press-fitting, through-hole, etc.

The backplane connector 20 comprises a first surface 21, a second surface 22, a first pin slot 25 and a second pin slot 26 located at the first surface 21 (see FIG. 1B) adapted to cooperate with a first tongue extension 13 and a second tongue extension 14 of the first complementary electrical connector 10, a plurality of pin grooves 27 (see FIG. 1B) within each pin slot extending from the first surface 21 to the second surface 22, and a plurality of pins assembled within the pin grooves 27.

Provided on the backplane 2 are a plurality of circuit traces which are grouped to form a first trace set 3 and a second trace set 4. The pins in the backplane connector 20 are further grouped to form a first pin set 23 and a second pin set 24 wherein one end of the pins in the first pin set 23 are attached to the circuit traces in the first trace set 3 and one end of the pins in the second pin set 24 are attached to the circuit traces in the second trace set 4.

Assembled on the first tongue extension 13 of the first complementary electrical connector 10 is a first terminal set 11 wherein each terminal in the first terminal set 11 is configured to connect electrically with a pin in the first pin set 23 of the backplane connector 20 when the two connectors mate. Similarly, assembled on the second tongue extension 14 of the first complementary electrical connector 10 is a second terminal set 12 wherein each terminal in the second terminal set 12 is configured to connect electrically with a pin in the second pin set 24 of the backplane connector 20 when the two connectors mate.

The circuit traces in the first trace set 3 provide a means by which the data signals may be exchanged between the test equipment and the HDD to be tested and the circuit traces in the second trace set 4 provide a means by which power may be provided from the test equipment to the HDD to be tested. The number, the arrangement and the pitch of the circuit traces that are provided on the backplane 2 may correspond to the number, the arrangement and the pitch of the pins on the backplane connector 20. The number, the arrangement and the pitch of the pins on the backplane connector 20 will have an impact on the types of HDD connectors that can be used to establish the electrical connection between the test equipment and the HDD to be tested. For example, if the backplane connector 20 is a SATA socket (as shown in FIG. 1A) with 7 data signal pins in the first pin set and 15 power pins in the second pin set, then only HDDs with a SATA header having 7 data signal terminals in the first terminal set and 15 power terminals in the second terminal set may be tested.

It is clear to one skilled in the art that the number of circuit traces on the backplane 2 may be more than or equal to the number of pins in the backplane connector 20. Also, the number of terminals in the first complementary electrical connector 10 may be less than the number of pins in the backplane connector 20. In both situations, the backplane connector 20 and the first complementary electrical connector 10, when mated, may be able to provide an electrical interface between the test equipment attached to the backplane 2 and the HDD attached to the PCB 1 if the pins in the backplane connector 20 may be aligned to the corresponding circuit traces on the backplane 2 as specified in accordance to the SFF specifications for that HDD interface and/or the terminals in the first complementary electrical connector 10 may be aligned to the corresponding pins in the backplane connector 20 as specified according to the SFF specifications for that HDD interface.

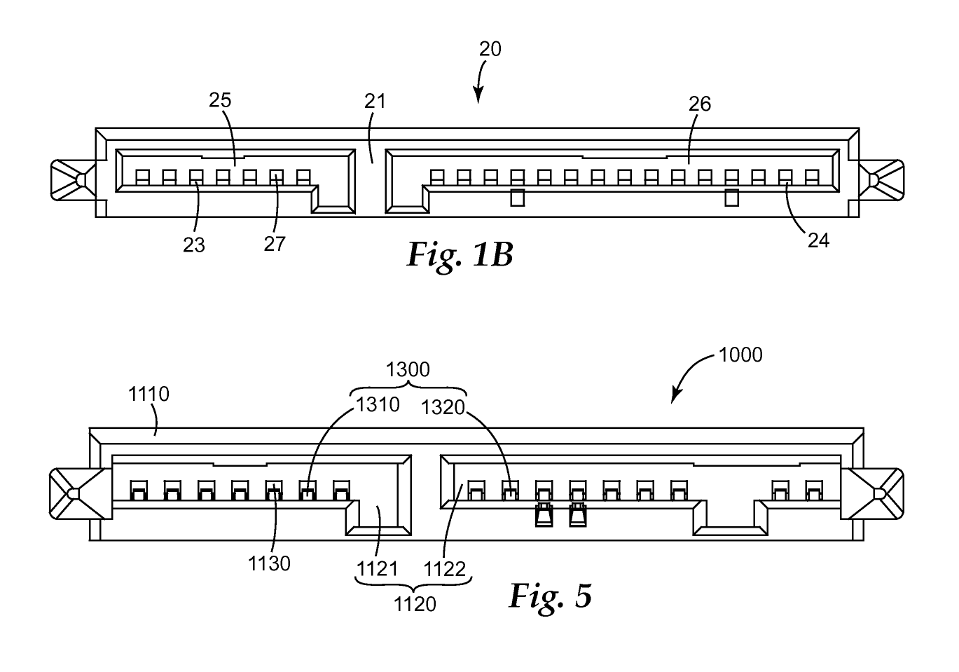

In FIG. 2, a backplane connector 30 such as a SAS socket further comprises in addition to backplane connector 20 a third pin set 28 wherein each pin in the third pin set 28 is attached to a circuit trace belonging to a third trace set 5 on a backplane 6. Test equipment (not shown) attached to the backplane 6 whereby the backplane connector 30 is attached may thus be used to test a HDD (not shown) attached to a PCB 1 with another first complementary electrical connector such as a SAS header (not shown) having a third terminal set wherein each terminal in the third terminal set is configured to connect electrically with a pin in the third pin set 28 of the backplane connector 30 when the two connectors mate.

It is clear to one skilled in the art that although the first complementary electrical connector 10 such as a SATA header as shown in FIG. 2 does not have a third terminal set configured to connect electrically with the third pin set 28 of the backplane connector 30 such as a SAS socket as shown in FIG. 2, the test equipment attached to the backplane 6 wherein the backplane connector 30 is attached, may still be used to test a HDD attached to the PCB 1 where the first complementary electrical connector 10 is attached if the third pin set 28 of the backplane connector 30 has no corresponding function or use in the first complementary electrical connector 10 and if each terminal in the first terminal set 11 and the second terminal set 12 of the first complementary electrical connector 10 are aligned to a pin in the first pin set 23 and the second pin set 24 of the backplane connector 30. Accordingly, if terminals of a first complementary electrical connector are not aligned to pins of a backplane connector, test equipment attached to a backplane wherein the backplane connector is attached may not be used to test a HDD attached to a PCB wherein the first complementary electrical connector is attached.

It would be desirable to provide an electrical connector that can be used to couple and electrically connect a first complementary electrical connector of an HDD to a backplane connector of test equipment even when terminals of the first complementary electrical connector are not aligned to pins of the backplane connector.

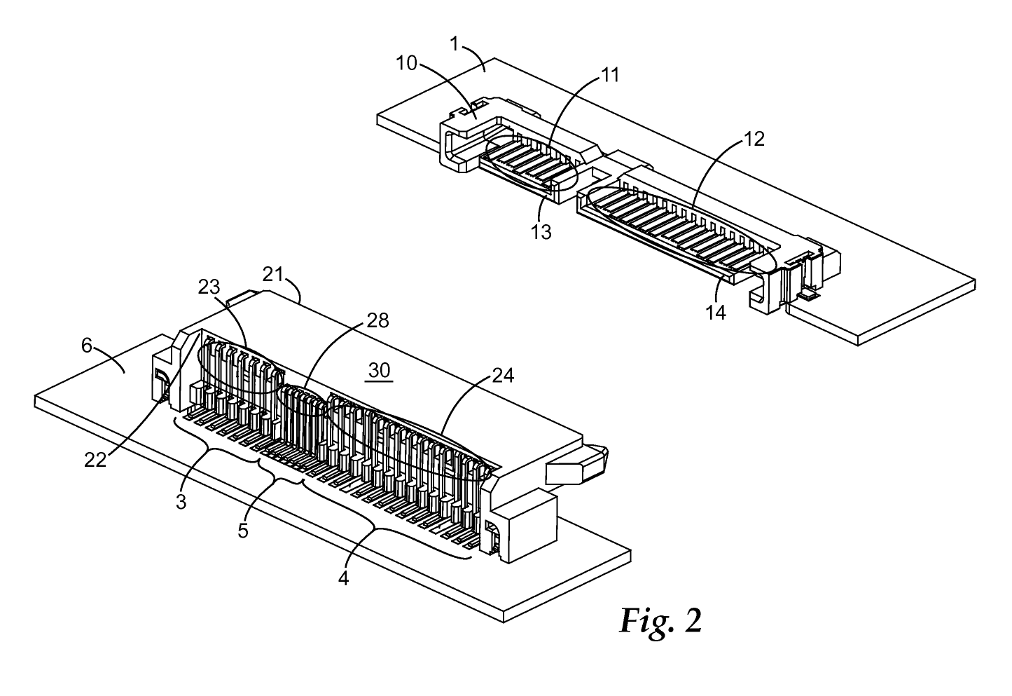

FIG. 3 is a perspective view of one embodiment of an interconnect system in accordance to an aspect of the present invention comprising a first complementary electrical connector 100 such as a micro SATA header attached to a PCB 40 which is attached to a HDD (not shown), a second complementary electrical connector 200 such as a SATA socket attached to a backplane 2 which is attached to a test equipment (not shown) and one embodiment of an exemplary electrical connector 1000 according to an aspect of the present invention positioned between and ready to mate with the second complementary electrical connector 200 and the first complementary electrical connector 100.

In this embodiment, the second complementary electrical connector 200 is similarly configured and similarly attached to the backplane 2 as the backplane connector 20 described earlier. The first complementary electrical connector 100 comprises an elongated body 110 having a first side 111 and a second side 112; a first tongue extension 121 and a second tongue extension 122, both tongue extensions extending from the second side 112 of the body 110; and a plurality of terminals grouped to form a first terminal set 131 and a second terminal set 132 wherein terminals in the first terminal set 131 are assembled in the first tongue extension 121 and terminals in the second terminal set 132 are assembled in the second tongue extension 122. While each terminal in the first terminal set 131 of the first complementary electrical connector 100 is aligned to a pin in the first pin set 23 of the second complementary electrical connector 200, the terminals in the second terminal set 132 of the first complementary electrical connector 100 are not in alignment with the pins in the second pin set 24 of the second complementary electrical connector 200. As explained earlier, the first complementary electrical connector 100 will not be able to couple directly with and connect electrically with the second complementary electrical connector 200 and as a result, test equipment attached to the backplane 2 on which the second complementary electrical connector 200 is also attached cannot be used to test the HDD attached to the PCB 40 on which the first complementary electrical connector 100 is also attached.

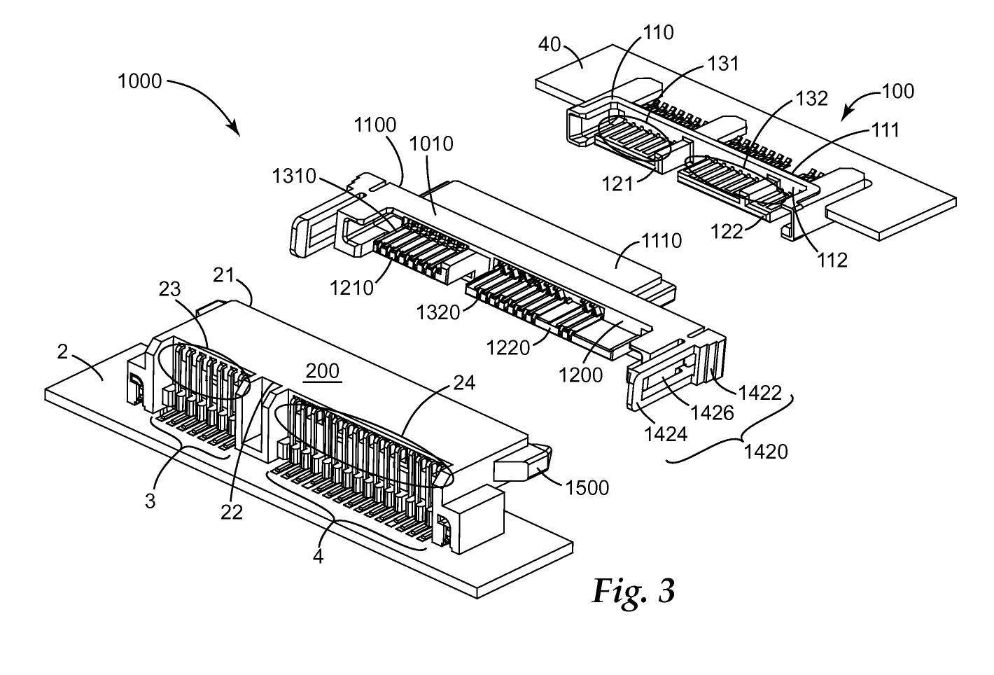

FIG. 4 is an exploded perspective view of the exemplary electrical connector 1000. The electrical connector 1000 comprises an elongated insulative housing having a longitudinal base portion 1010 with a first mating end 1100, a second mating end 1200, an extension 1110 extending from the first mating end 1100 of the base portion 1010, a tongue portion comprising a first tongue section 1210 and a second tongue section 1220 extending from the second mating end 1200 of the base portion 1010, and a plurality of contacts 1300 grouped to form a first contact set 1310 and a second contact set 1320 extending from the extension 1110 to the tongue portion. In one embodiment, the contacts in the first contact set 1310 are positioned within the first tongue section 1210 while the contacts in the second contact set 1320 are positioned within the second tongue section 1220.

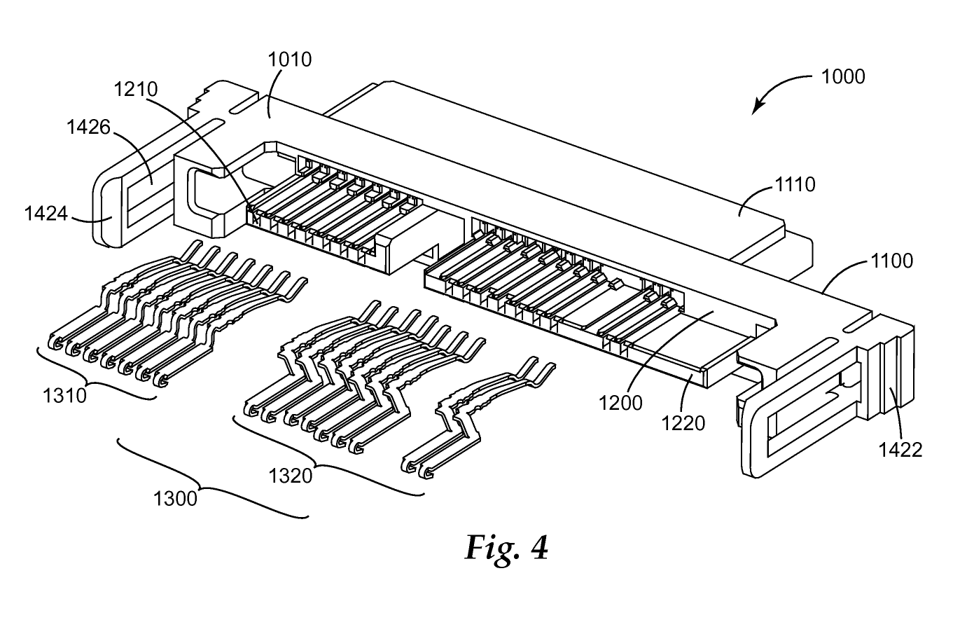

As shown in FIG. 5, provided at one end of the extension 1110 of the electrical connector 1000 is a plurality of slots 1120 having a plurality of grooves 1130 extending from the extension 1110 to the tongue portion and in which the contacts 1300 are placed. In one embodiment, the slot comprises a first slot 1121 and a second slot 1122 wherein the first slot 1121 houses the first contact set 1310 and the second slot 1122 houses the second contact set 1320.

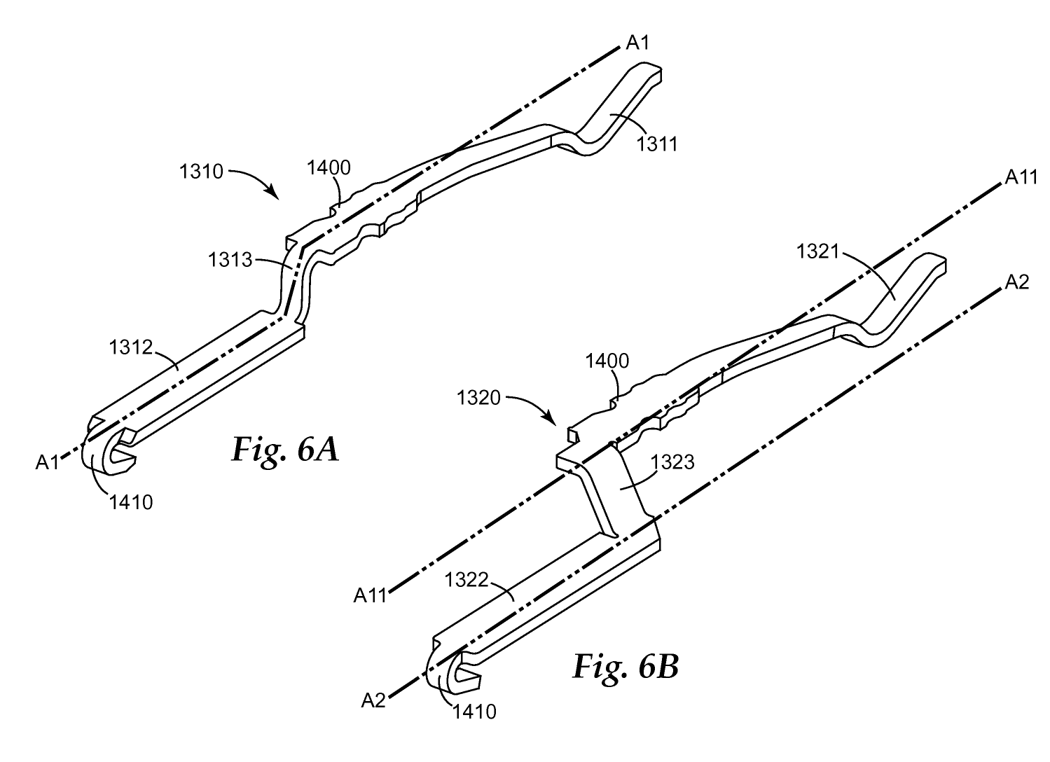

FIG. 6A is a perspective view of one embodiment of a contact from the first contact set 1310 in accordance to an aspect of the present invention while FIG. 6B is a perspective view of one embodiment of a contact from the second contact set 1320 in accordance to an aspect of the present invention. In one embodiment, the contact in the first contact set 1310 comprises a first contact section 1311, a second contact section 1312 and a bridging section 1313 connecting the first contact section 1311 to the second contact section 1312 and the contact in the second contact set 1320 comprises a first contact section 1321, a second contact section 1322 and a bridging section 1323 connecting the first contact section 1321 to the second contact section 1322. In one embodiment, provided near one end of the first contact section 1311, 1321 of the contact in the first contact set 1310 and/or second contact set 1320 is a plurality of securing devices such as barbs 1400 which are used to secure the contacts 1300 to the housing of the electrical connector 1000.

In one embodiment, the first contact sections 1311, 1321 of the contacts in the first contact set 1310 and/or the second contact set 1320 are of cantilever beam structures and provided at one end of the second contact sections 1321, 1322 of the contacts in the first contact set 1310 and/or the second contact set 1320 are securing devices such as U-shaped structures 1410. The U-shaped structures 1410 secure the second contact sections 1312, 1322 of the contacts 1300 to the tongue portion so as to prevent the contacts from lifting off the tongue portion during the mating and the un-mating of the electrical connector 1000 and the second complementary electrical connector 200.

In one embodiment, the first contact sections 1311 and the second contact sections 1312 of the contacts in the first contact set 1310 are aligned substantially along a same axis A1-A1 whereas the first contact sections 1321 and the second contact sections 1322 of the contacts in the second contact set 1320 are aligned along different axes A11-A11, A2-A2. The axis A11-A11 may be parallel to or may be at an angle to the axis A2-A2.

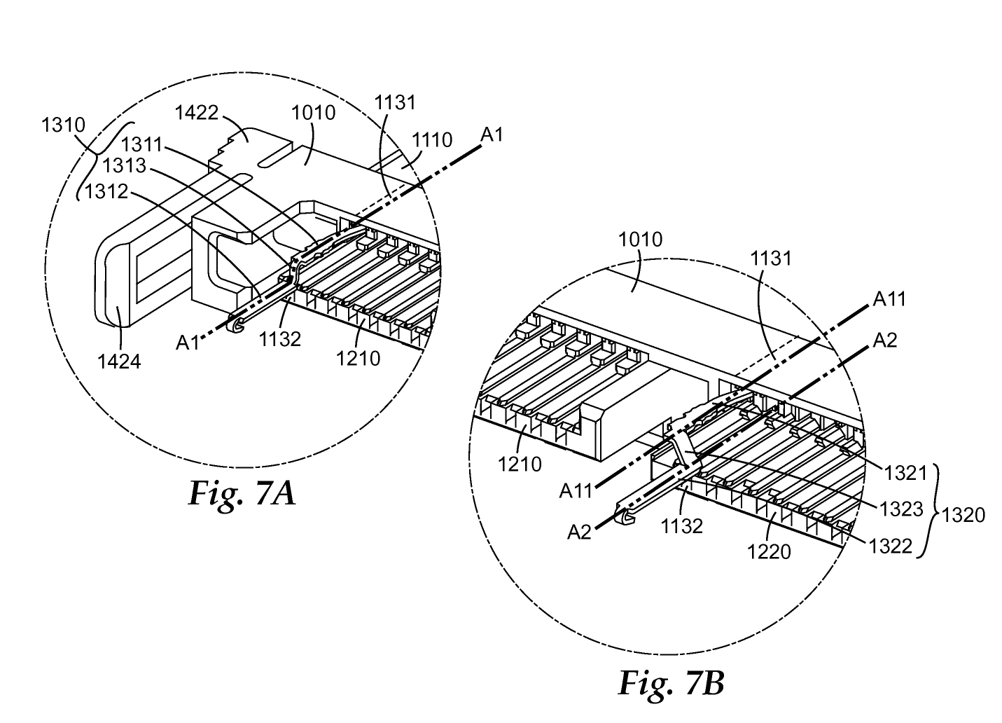

Accordingly, as illustrated by FIGS. 5, 7A and 7B, both a first section 1131 and a second section 1132 of the grooves 1130 in the first slot 1121 in which the contacts belonging to the first contact set 1310 are fitted extend along the axis A1-A1 from the first tongue section 1210 to the extension 1110 while a first section 1131 of the grooves 1130 in the second slot 1122 extend along the axis A11-A11 at the extension 1110 and a second section 1132 of the grooves 1130 in the second slot 1122 extend along the axis A2-A2 at the second tongue section 1220 so that the contacts from the second contact set 1320 may be fitted in the grooves.

During mating, the terminals in the first terminal set 131 of the first complementary electrical connector 100 and the pins in the first pin set 23 of the second complementary electrical connector 200 are aligned to the first contact sections 1311 and second contact sections 1312 of the contacts in the first contact set 1310 which are aligned to the axis A1-A1; the terminals in the second terminal set 132 of the first complementary electrical connector 100 are aligned to the first contact sections 1321 of the contacts in the second contact set 1320 which are aligned to the axis A11-A11 and the pins in the second pin set 24 of the second complementary electrical connector 200 are aligned to the second contact sections 1322 of the contacts in the second contact set 1320 which are aligned to the axis A2-A2.

By configuring the first contact sections 1321 of the contacts in the second contact set 1320 to align along a different axis from the second contact sections 1322 of the contacts in the second contact set 1320, the electrical connector 1000 is now able to couple two electrical connectors such as the first complementary electrical connector 100 and the second complementary electrical connector 200 wherein the terminals in one electrical connector may not be aligned to the pins in the other electrical connector.

One benefit of using such a method and the exemplary electrical connector 1000 is the ability to use test equipment which has one type of HDD interface to test a HDD which has another type of HDD interface. In doing so, it is possible to reduce operating costs and maximize resources by using existing test equipment to test new HDDs as they are developed and introduced in the industry to meet the HDD demands of new electronic devices. Other benefits of using an intermediate electrical connector (sometimes referred to as “sacrificial connector”) to couple a plurality of complementary electrical connectors with high mating cycles requirement are discussed in a Singapore Patent Application No. 200701728-8.

In one embodiment, the electrical connector 1000 further comprises a bonding device such as a latching device 1420 (see FIG. 3) with a latch release 1422, a latch member 1424 extending away from the second mating end 1200 and a hole 1426 in the latch member 1424. As the electrical connector 1000 mates with the second complementary electrical connector 200 at the second mating end 1200, a protrusion 1500 coupled to an end wall on the second complementary electrical connector 200 adapted to cooperate with the latching device 1420 pushes the latch member 1424 outwards away from the end wall of the second complementary electrical connector 200 as the latch member 1424 rides over the slope of protrusion 1500. As the latch member 1424 passes the ridge of the protrusion 1500, the hole 1426 in the latch member 1424 engages with the protrusion 1500 of the second complementary electrical connector 200 causing the latch member 1424 to fall back to its original horizontal position. This is the locked position of the latching device 1420 and the electrical connector 1000 is firmly coupled to the second complementary electrical connector 200. To de-couple the electrical connector 1000 from the second complementary electrical connector 200, the latch release 1422 is depressed inwards towards the base portion 1010 of the electrical connector 1000. In doing so, the hole 1426 in the latch member 1424 disengages with the protrusion 1500 on the second complementary electrical connector 200, and the two connectors 1000, 200 can be easily de-coupled by pulling the electrical connector 1000 in a direction away from the second complementary electrical connector 200.

For a manufacturer of test equipment, the invention also presents a way in which the manufacturer may manufacture test equipment for testing HDD attached with a first electrical connector of a first HDD interface using existing backplane with circuit traces configured for a second electrical connector of a second HDD interface wherein the terminals in the first electrical connector may not be aligned with the circuit traces on the backplane configured for the second electrical connector. This allows the manufacturer of test equipment to save costs and reduce wastage by using the existing backplanes in stock.

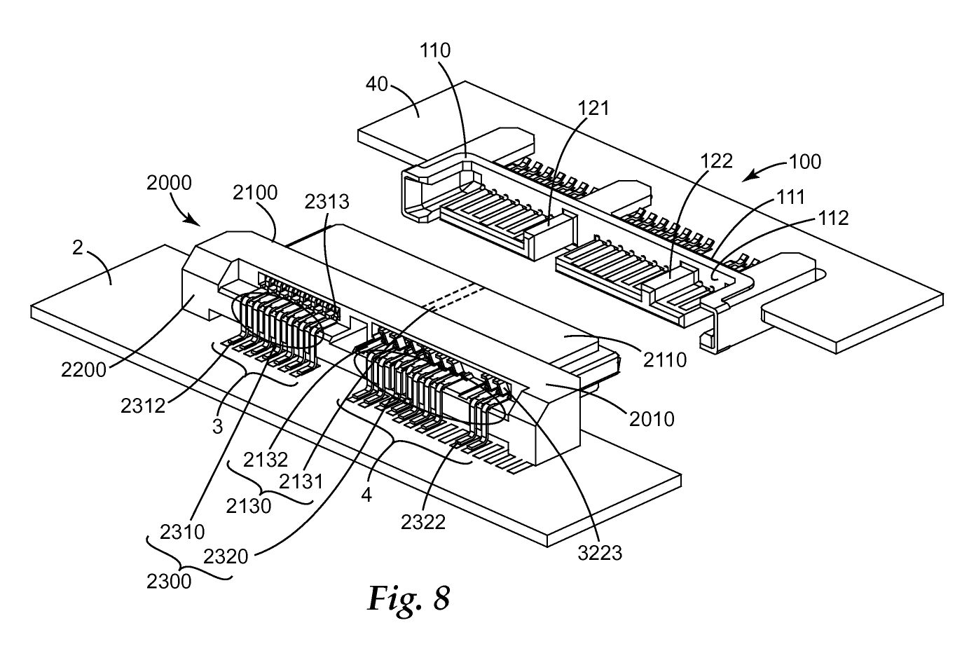

FIG. 8 is a perspective view of one embodiment of an interconnect system in accordance to an aspect of the present invention comprising one embodiment of an exemplary electrical connector in accordance to an aspect of the present invention attached to a backplane 2 which is to be attached to a test equipment (not shown) and a first complementary electrical connector 100 attached to a PCB 40 which is to be attached to a HDD (not shown).

The electrical connector 2000 comprises an elongated insulative housing 2010 having a first mating end 2100 and a second mating end 2200, an extension 2110 extending from the first mating end 2100 of the housing, and a plurality of contacts 2300 grouped to form a first contact set 2310 and a second contact set 2320 extending from the extension to the second mating end 2200.

In one embodiment, the first mating end 2100 is configured to couple with the first complementary electrical connector 100 by means of a plurality of slots (not shown) provided at one end of the extension 2110 having a plurality of grooves 2130 extending from the extension 2110 to the second mating end 2200; wherein the slots are similarly grouped into a first slot and a second slot as the slots 1120 in FIG. 5 and the grooves 2130 are similarly in structured and configured with a first section 2131 and a second section 2132 as shown in FIGS. 7A and 7B.

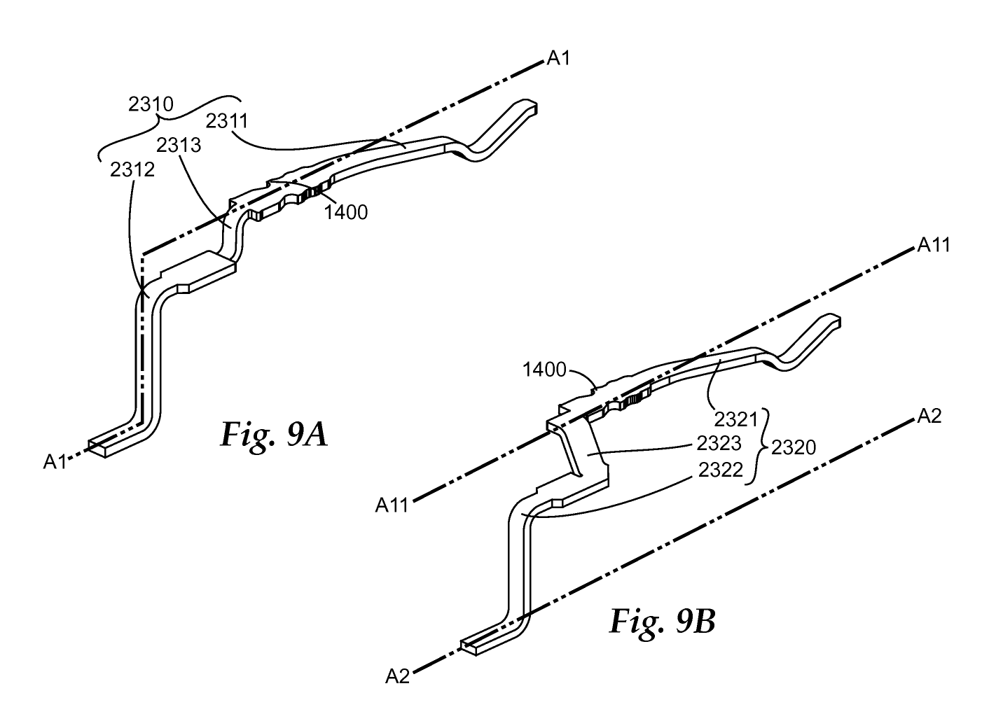

In one embodiment, the contacts in the first contact set 2310 comprises a first contact section 2311, a second contact section 2312 and a bridging section 2313 connecting the first contact section 2311 to the second contact section 2312 as illustrated by the perspective view in FIG. 9A and the contacts in the second contact set 2320 comprises a first contact section 2321, a second contact section 2322 and a bridging section 2323 connecting the first contact section 2321 to the second contact section 2322 as illustrated by the perspective view in FIG. 9B.

In one embodiment, the first contact sections 2311 and the second contact sections 2312 of the contacts in the first contact set 2310 are aligned substantially along a same axis A1-A1 whereas the first contact sections 2321 and the second contact sections 2322 of the contacts in the second contact set 2320 are aligned along different axes A11-A11, A2-A2.

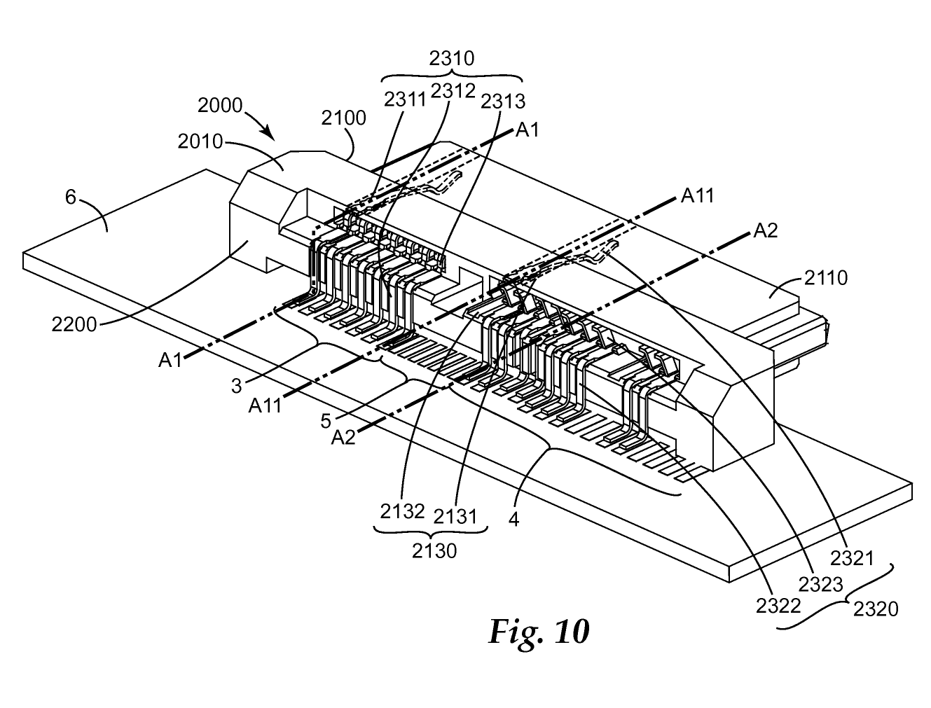

FIG. 10 is a perspective view of another embodiment of the invention wherein the electrical connector 2000 is attached to a backplane 6 having a first trace set 3, a second trace set 4 and a third trace set 5 similar to a backplane configured with a SAS HDD interface. The first section 2131 and the second section 2132 of the grooves 2130 in the first slot in which the contacts belonging to the first contact set 2310 are fitted extend along the axis A1-A1 from the extension 2110 to the second mating end 2200 while the first section 2131 of the grooves 2130 in the second slot extend along the axis A11-A11 at the extension 1110 and the second section 2132 of the grooves 2130 in the second slot extend along the axis A2-A2 at the second mating end 2200 so that the contacts from the second contact set 2320 may be fitted in the grooves.

During mating, the terminals in the first terminal set 131 of the first complementary electrical connector 100 (see FIG. 3) are aligned to the first contact sections 2311 of the contacts in the first contact set 2310 which are aligned to the axis A1-A1 and the terminals in the second terminal set 132 of the first complementary electrical connector 100 are aligned to the first contact sections 2321 of the contacts in the second contact set 2320 which are aligned to the axis A11-A11. The second contact sections 2312, 2322 of the contacts in the first contact set 2310 and the second contact set 2320 may be attached to the backplane 2 in many ways including soldering the second contact sections 2312, 2322 to a plurality of circuit traces from the first trace set 3 and second trace set 4 respectively. By aligning the first contact sections 2321 and the second contact sections 2322 of the contacts in the second contact set 2320 along different axes A11-A11 and A2-A2, it is possible to establish electrical connection between the circuit traces of the second trace set 4 with the terminals of the second terminal set 132 even though they are initially not in alignment.

The foregoing description of various preferred embodiments of the invention has been presented for purposes of illustration and description. It is not intended to be exhaustive or to limit the invention to the precise forms disclosed, since many modifications or variations thereof are possible in light of the above teaching. All such modifications and variations are within the scope of the invention. The embodiments described herein were chosen and described to best explain the principles of the invention and its practical application, thereby to enable others skilled in the art to utilize the invention in various embodiments and with various modifications as are suited to the particular use contemplated thereof. It is intended that the scope of the invention be defined by the claims appended hereto, when interpreted in accordance with the full breadth to which they are legally and equitably suited.

1. An electrical connector comprising:
an elongated insulative housing having a longitudinal base portion with a first mating end and a second mating end;
wherein the first mating end is configured to couple with a first complementary electrical connector by means of a plurality of slots defined within an extension extending from the base portion;
wherein the second mating end is configured to couple with a second complementary electrical connector by means of a tongue portion extending from the base portion, the tongue portion comprising a first tongue section and a second tongue section; and
a plurality of contacts extending from the extension to the tongue portion, each contact comprising a first contact section, a second contact section and a bridging section connecting the first contact section to the second contact section, and the contacts are further grouped to form a first contact set and a second contact set wherein the first contact section and the second contact section of each contact in the first contact set are aligned substantially along a same axis whereas the first contact section and the second contact section of each contact in the second contact set are aligned along different axes.

2. The electrical connector of claim 1 wherein a first axis along which the first contact section of a contact in the second contact set is aligned to is substantially parallel to a second axis along which the second contact section of the contact in the second contact set is aligned to.

3. The electrical connector of claim 1 wherein the contacts grouped in the first contact set are positioned within the first tongue section and the contacts grouped in the second contact set are positioned within the second tongue section.

4. The electrical connector of claim 1 wherein either the first contact section or the second contact section of each contact is of a cantilever beam structure.

5. The electrical connector of claim 1 wherein either the first contact section or the second contact section of each contact has a U-shaped structure at one end.

6. The electrical connector of claim 1 wherein the first contact section of each contact is of a cantilever beam structure and the second contact section of each contact has a U-shaped structure at one end of the second contact section.

7. An interconnect system comprising at least one electrical connector, a first complementary electrical connector and a second complementary electrical connector wherein the electrical connector is configured to couple the first complementary electrical connector and the second complementary electrical connector; and wherein
the first complementary electrical connector is attached to a printed circuit board which is attached to a hard disk drive;
the second complementary electrical connector is attached to a backplane which is attached to test equipment; and wherein
said electrical connector comprises:
an elongated insulative housing having a longitudinal base portion with a first mating end and a second mating end; wherein the first mating end is configured to couple with the first complementary electrical connector by means of a plurality of slots defined within an extension extending from the base portion and the second mating end is configured to couple with the second complementary electrical connector by means of a tongue portion extending from the base portion, the tongue portion comprising a first tongue section and a second tongue section; and
a plurality of contacts extending from the extension to the tongue portion, each contact comprising a first contact section, a second contact section and a bridging section connecting the first contact section to the second contact section, and the contacts are further grouped to form a first contact set and a second contact set wherein the first contact section and the second contact section of each contact in the first contact set are aligned substantially along a same axis whereas the first contact section and the second contact section of each contact in the second contact set are aligned along different axes.

8. The interconnect system of claim 7 wherein a first axis along which the first contact section of a contact in the second contact set is aligned to is substantially parallel to a second axis along which the second contact section of the contact in the second contact set is aligned to.

9. The interconnect system of claim 7 wherein the contacts grouped in the first contact set are positioned within the first tongue section and the contacts grouped in the second contact set are positioned within the second tongue section.

10. The interconnect system of claim 7 wherein either the first complementary electrical connector or the second complementary electrical connector is a micro SATA connector.

11. An electrical connector on a backplane comprising:
an elongated insulative housing having a first mating end and a second mating end;
wherein the first mating end is configured to couple with a first complementary electrical connector by means of a plurality of slots defined within an extension extending from the first mating end of the housing; and
a plurality of contacts extending from the extension to the second mating end, each contact comprising a first contact section, a second contact section attached to the backplane and a bridging section connecting the first contact section to the second contact section, and the contacts are further grouped to form a first contact set and a second contact set wherein the first contact section and the second contact section of each contact in the first contact set are aligned substantially along a same axis whereas the first contact section and the second contact section of each contact in the second contact set are aligned along different axes.

12. The electrical connector of claim 11 wherein a first axis along which the first contact section of a contact in the second contact set is aligned to is substantially parallel to a second axis along which the second contact section of the contact in the second contact set is aligned to.

13. The electrical connector of claim 11 wherein the contacts grouped in the first contact set are positioned within the first tongue section and the contacts grouped in the second contact set are positioned within the second tongue section.

14. An interconnect system comprising the electrical connector of claim 11 and a hard disk drive attached to the first complementary electrical connector via a printed circuit board.

15. The interconnect system of claim 14 wherein the first complementary electrical connector is a micro SATA connector.
